(19) United States
(12) Patent Application Publication
(10) Pub. No.: US 2026/0307157 A1
(43) Pub. Date: Oct. 8, 2026

(54) SELF-SHARPENING CUTTING DEVICE WITH GRADUALLY PHASED MATERIALS

(71) Applicant: Loubert S. Suddaby, Orchard Park, NY (US)

(72) Inventor: Loubert S. Suddaby, Orchard Park, NY (US)

(21) Appl. No.: 19/635,946

(22) Filed: Apr. 1, 2026

Related U.S. Application Data
(60) Provisional application No. 63/785,086, filed on Apr. 8, 2025.

(51) Int. Cl. B23B 51/02

(52) U.S. Cl. CPC B23B 51/02; B23B 2222/84; B23B 2222/92; B23B 2226/315

(57) ABSTRACT

A self-sharpening drill bit, comprising an axis of rotation, a shank, a tip, the tip comprising, at least one major cutting edge, a first land extending in a first circumferential direction and a first axial direction from the at least one major cutting edge and ending at a heel, and a flute section including, at least one flute extending from the tip, a minor cutting edge arranged at a first side of the at least one flute, and a second land arranged at a second side of the at least one flute, opposite the first side, wherein the self-sharpening drill bit comprises a plurality of sections, each section of the plurality of sections comprises a material hardness, and the material hardness of the plurality of sections decreases in the first circumferential direction from at least one of the major cutting edge and the minor cutting edge.

### CROSS-REFERENCE TO RELATED APPLICATIONS

This application claims the benefit under 35 U.S.C. § 119 (e) of U.S. Provisional Application No. 63/785,086, filed Apr. 8, 2025, which application is incorporated herein by reference in its entirety.

### FIELD

The present disclosure relates to cutting tools, and more particularly, to a cutting tool that wears at a non-constant rate to maintain a sharp cutting edge, and more particularly, to a self-sharpening twist drill bit.

### BACKGROUND

A drill bit is a cutting tool used in a drill to remove material to create holes, almost always of circular cross-section. Drill bits come in many sizes and shapes and can create different kinds of holes in many different materials. In order to create holes drill bits are usually attached to a drill, which powers them to cut through the workpiece, typically by rotation. The drill will grasp the upper end of a bit called the shank in the chuck.

Traditional twist drill bits experience wear primarily at the cutting edge or lip, leading to a loss of cutting efficiency, increased friction, and overheating. Current drill bits require regular sharpening, resulting in downtime and reduced productivity.

Thus, there is a long-felt need for a drill bit that maintains a sharp cutting edge.

### SUMMARY

The present disclosure is directed to one or more exemplary embodiments of a self-sharpening drill bit.

In an exemplary embodiment, the self-sharpening drill bit may comprise an axis of rotation, a proximal end, a distal end including a tip, the tip comprising at least one major cutting edge, a first land extending in a first circumferential direction and a first axial direction from the at least one major cutting edge and ending at a heel, and a flute section including at least one flute extending from the tip, a minor cutting edge arranged at a first side of the at least one flute, and a second land arranged at a second side of the at least one flute, opposite the first side, wherein the self-sharpening drill bit comprises a plurality of sections, each section of the plurality of sections comprises a material hardness, and the material hardness of the plurality of sections decreases in the first circumferential direction from at least one of the major cutting edge and the minor cutting edge.

In an exemplary embodiment, the self-sharpening drill bit, comprises an axis of rotation, a proximal end including a shank, a distal end including a tip, the tip comprising at least one major cutting edge, a first land extending in a first circumferential direction and a first axial direction from the at least one major cutting edge and ending at a heel, and a flute section including at least one flute extending from the tip, a minor cutting edge arranged at a first side of the at least one flute, and a second land arranged at a second side of the at least one flute, opposite the first side, wherein the self-sharpening drill bit comprises a plurality of sections, each section of the plurality of sections comprises a material hardness, and the material hardness of the plurality of sections decreases in the first circumferential direction from at least one of the major cutting edge and the minor cutting edge.

In an exemplary embodiment, the plurality of sections comprises a first section forming the major cutting edge and/or the minor cutting edge, the first section including a first hardness, and a second section arranged circumferentially adjacent to the first section and having a second hardness, less than the first hardness. In an exemplary embodiment, the plurality of sections further comprises a third section arranged circumferentially adjacent to the second section and having a third hardness, less than the first hardness, and a fourth section arranged circumferentially adjacent to the third section and having a fourth hardness, less than the third hardness. In an exemplary embodiment, the first section comprises polycrystalline diamond (PCD), the second section comprises tungsten carbide, the third section comprises a transition from high-carbon steel to low-carbon steel, and the fourth section comprises aluminum and/or copper.

In an exemplary embodiment, the first section comprises a first protrusion that extends into the second section, and/or the second section comprises a second protrusion that extends into the first section. In an exemplary embodiment, the first protrusion and the second protrusion extend in a radial direction and an axial direction with respect to the axis of rotation. In an exemplary embodiment, the plurality of sections increase in width in the first circumferential direction. In an exemplary embodiment, at least one section of the plurality of sections comprises a circumferential portion extending completely from the major cutting edge to the first heel, and a radial portion extending from the circumferential portion along the major cutting edge to a cutting edge shoulder.

In an exemplary embodiment, at least one section of the plurality of sections comprises a circumferential portion extending to the first heel, and a radial portion extending from the circumferential portion to a radially outward facing surface of the self-sharpening drill bit. In an exemplary embodiment a first section forms the minor cutting edge and extends from the flute to the second land, and the second section extends from the flute to the second land.

The present disclosure is directed to one or more exemplary embodiments of a self-sharpening drill bit.

In an exemplary embodiment, the self-sharpening drill bit comprises an axis of rotation, a proximal end including a shank, a distal end including a tip, the tip comprising at least one major cutting edge, a first land extending in a first circumferential direction and a first axial direction from the at least one major cutting edge and ending at a heel, a flute section including at least one flute extending from the tip, a minor cutting edge arranged at a first side of the at least one flute, and a second land arranged at a second side of the at least one flute, opposite the first side, wherein the self-sharpening drill bit comprises a plurality of layers arranged in a first circumferential direction from the major cutting edge to the first heel and/or the minor cutting edge to the second heel, each layer of the plurality of layers comprises a material hardness, and the material hardness of each layer decreases in the first circumferential direction.

In an exemplary embodiment, the plurality of layers comprise a first layer forming the major cutting edge and/or the minor cutting edge, the first layer including a first hardness, a second layer arranged circumferentially adjacent to the first layer and having a second hardness, less than the first hardness, a third layer arranged circumferentially adjacent to the second layer and having a third hardness, less than the first hardness, and a fourth layer arranged circumferentially adjacent to the third layer and having a fourth hardness, less than the third hardness. In an exemplary embodiment, the first layer comprises PCD, the second layer comprises tungsten carbide, the third layer comprises a transition from high-carbon steel to low-carbon steel, and the fourth layer comprises aluminum and/or copper.

In an exemplary embodiment, the plurality of layers comprise a first layer comprising a first material and a second layer comprising a second material, different than the first material, and the first layer comprises at least one protrusion including the first material and extending into the second layer. In an exemplary embodiment, the at least one protrusion extends in a radial direction and an axial direction with respect to the axis of rotation. In an exemplary embodiment, the plurality of layers increase in width in the first circumferential direction.

In an exemplary embodiment, at least one layer of the plurality of layers comprise a circumferential portion extending to the first heel, and a radial portion extending from the circumferential portion to a radially outward facing surface of the self-sharpening drill bit. In an exemplary embodiment, the plurality of layers comprise a first layer forming the minor cutting edge, the first layer including a first hardness, the first layer extending from the flute to the second land, and a second layer arranged circumferentially adjacent to the first layer and having a second hardness, less than the first hardness, the second layer extending from the flute to the second land.

The present disclosure is directed to one or more exemplary embodiments of a self-sharpening cutting tool.

In an exemplary embodiment, the self-sharpening cutting tool comprises a first side, a second side, a cutting edge, the first side and the second side forming the cutting edge, and a functionally graded material gradually decreasing in hardness in a direction away from the cutting edge.

In an exemplary embodiment, the self-sharpening cutting tool is configured to form a hole in a substrate. In an exemplary embodiment, the functionally graded material comprises a first functionally graded material zone forming the cutting edge and including a first majority material having a first hardness, and a second functionally graded material zone arranged adjacent the cutting edge and including a second majority material having a second hardness, less than the first hardness.

The present disclosure is directed to one or more exemplary embodiments of a self-sharpening tool.

In an exemplary embodiment, the self-sharpening tool comprises a first side, a second side, a cutting edge, the first side and the second side forming the cutting edge, a first section forming the cutting edge and including a first majority material having a first hardness, and a second section including a second majority material having a second hardness, less than the first hardness.

In an exemplary embodiment, the first section extends completely from the first side to the second side, and the second section extends completely from the first side to the second side.

The present disclosure is directed to one or more exemplary embodiments of a self-sharpening twist drill bit. In an exemplary embodiment, the self-sharpening twist drill bit may be manufactured using additive manufacturing (AM) and may comprise a cutting lip composed of PCD or equivalent ultra-hard material, a transition zone of tungsten carbide fading to high-carbon steel, and a core and/or heel section made from low-carbon steel, aluminum, and/or copper, which preferentially wears away.

The present disclosure is directed to one or more exemplary embodiments of a drilling tool. In an exemplary embodiment, the drilling tool wherein the softer materials at the heel degrade faster than the cutting edge, thereby continuously exposing a sharp lip.

The present disclosure is directed to one or more exemplary embodiments of an AM method for producing a gradient material drill bit, wherein the material density transitions from PCD to tungsten carbide to high-carbon steel to softer metals, ensuring controlled wear.

The present disclosure is directed to one or more exemplary embodiments of a self-sharpening mechanism in a drill bit, wherein the wear rate of the heel area is greater than that of the cutting lip area, ensuring extended tool life without manual sharpening.

The present disclosure relates to drilling tools, specifically to a self-sharpening twist drill which can be manufactured through AM techniques. The drill is designed to maintain a sharp cutting edge by preferentially wearing away less dense material near the heel while exposing a continuously sharp lip. AM enables precise control of material composition and density, and can be used in the manufacturing of the present self-sharpening drill bit.

In an exemplary embodiment, the drill bit comprises a graded material composition. The cutting lip is made of an ultra-hard material, such as PCD, transitioning to tungsten carbide, high-carbon steel, and then lower-carbon steels, before finally incorporating a softer material (e.g., aluminum or copper) at the heel. This gradient structure ensures that: the softer materials nearer the heel wear away faster, maintaining a constant cutting edge at the lip; the cutting lip remains sharp for extended periods, reducing the need for sharpening; and the drill retains its structural integrity and efficiency even after prolonged use.

In an exemplary embodiment, the drill bit comprises a cutting lip comprising PCD or a comparable ultra-hard material, providing a long-lasting sharp edge, a transition zone comprising a gradient composition of tungsten carbide to high-carbon steel, allowing strength while mitigating brittleness, and a core and/or heel comprising progressively softer materials, such as low-carbon steel, aluminum, and/or copper, which wear away first during use.

In an exemplary embodiment, the drill bit is fabricated using directed energy deposition (DED), Selective Laser Melting (SLM), and/or binder jetting, allowing layered material deposition with a gradual transition from ultra-hard materials to softer metals. By optimizing density and hardness gradients, wear occurs preferentially proximate or at the heel, ensuring a self-sharpening effect. The gradient design can be controlled at a microscopic level, eliminating the risk of abrupt material failure. As the drill bit is used, the heel material wears away faster than the lip, continuously exposing fresh cutting edges. The harder lip material remains intact while the supporting softer materials degrade, reducing the friction and heat associated with traditional dulling drill bits. The progressive material loss maintains the optimal cutting angle, extending the drill bit's operational life. The drill bit may be used in industrial machining for metal, composite, and hard-material drilling, aerospace, automotive, and precision manufacturing where downtime due to tool sharpening is costly, mining and oil exploration where high-wear-resistant drill bits are required, etc.

In an exemplary embodiment, the drill bit increases twist drill bit longevity and efficiency by leveraging AM to engineer material gradients that ensure a self-sharpening effect, minimizes downtime, improves cutting performance, and extends the drill bit's lifespan across various industrial applications.

In an exemplary embodiment, drill bit comprises a controllable mixture of metals to achieve an integrated conglomerate of different densities and hardness joined together through AM such that frictional wear characteristics can be coordinated so that operational use will continuously expose the hardest material which then becomes the cutting edge. The metal mixtures can be varied depending on the material being cut (wood, metal, stone, flesh, etc.).

The present disclosure relates to a self-sharpening twist drill, manufactured via AM, comprising a cutting lip composed of PCD or cubic boron nitride (CBN) for superior wear resistance, a transition zone composed of tungsten carbide fading into high-carbon steel, ensuring structural integrity, a core made of medium-carbon steel for mechanical strength and toughness, and a heel section composed of low-carbon steel, aluminum, or copper, which preferentially wears away to expose fresh cutting edges.

The present disclosure relates to a method of manufacturing a self-sharpening drill bit using AM, wherein the lip material (e.g., PCD, CBN, or tungsten carbide) is deposited first, ensuring maximum wear resistance, the transition zone material (e.g., WC—Co or TiC) is gradually blended with high-carbon steel, ensuring a smooth material gradient, and the heel section is printed using a softer metal, allowing controlled material degradation to expose fresh cutting edges.

The present disclosure relates to a self-sharpening mechanism for twist drills, wherein the softer materials at the heel degrade faster than the cutting edge, the worn regions do not affect drill performance, as fresh cutting material is continuously exposed, and the drill retains an optimal cutting geometry for extended use without requiring manual sharpening.

The present disclosure relates to an AM process for a functionally graded twist drill bit, wherein DED or SLM is used to create a material gradient, binder jetting is used for integrating ultra-hard materials like tungsten carbide or PCD into the drill structure, and/or internal coolant channels are incorporated via AM techniques for improved thermal performance.

In an exemplary embodiment, the drill bit comprises a combination of PCD or CBN cutting edges, tungsten carbide transition layers, and softer heel materials to ensure continuous sharpness and extended tool life.

The present disclosure relates to a hybrid manufacturing process for self-sharpening twist drills, integrating AM and subtractive finishing to optimize performance and production efficiency.

The present disclosure relates to a modular self-sharpening drill system, wherein the cutting tip is replaceable and manufactured via additive techniques, allowing for extended tool usability.

The present disclosure relates to a functionally graded drill bit composition, wherein the cutting lip comprises hard ceramic, carbide, or diamond-based materials, the transition layer is metallurgically bonded to a steel core, and the heel is composed of a lower-strength alloy, allowing preferential wear to maintain a sharp cutting edge.

The present disclosure relates to an advanced flute geometry optimized for self-sharpening drill bits, designed via computational modeling and AM, ensuring continuous cutting efficiency.

By integrating cost-effective material substitutions, hybrid manufacturing approaches, and modular drill designs, this self-sharpening twist drill becomes viable for both industrial and consumer markets. Some benefits include extended tool life (3-4 times longer lifespan than conventional drill bits, lower maintenance costs (eliminates or reduces downtime from manual sharpening, scalable manufacturing (combines AM with computer numerical control (CNC) for large-scale production), industry-specific customization (optimized for aerospace, construction, and woodworking applications), and sustainability (reduces material waste via modular and replaceable cutting edges).

The present application is directed to one or more embodiments of a self-sharpening drill bit, comprising a cutting edge formed from a first material with a hardness of greater than 8 on the Mohs scale (e.g., tungsten carbide, diamond), a base material forming the body of the drill bit, composed of a softer material with a hardness less than 6 on the Mohs scale (e.g., mild steel, aluminum alloys), and a gradient or layered material transition between the cutting edge and base material, wherein the intermediate layers or gradients provide structural integrity and controlled wear characteristics.

In an exemplary embodiment, the self-sharpening drill bit further comprises a coating or surface treatment on the cutting edge to enhance wear resistance and reduce friction during operation. In an exemplary embodiment, the transition between the cutting edge and the base material is layered in discrete, alternating layers of hard and soft materials, or gradual, with material properties such as hardness and toughness varying continuously from the cutting edge to the base. In an exemplary embodiment, the cutting edge is designed to self-sharpen due to differential wear rates between the hard material of the cutting edge and the softer material at the heel, and exposure of a fresh, sharp edge as softer materials wear away. In an exemplary embodiment, the manufacturing process includes AM (3D printing) techniques, such as laser powder bed fusion or DED, to precisely control material gradients and geometries. In an exemplary embodiment, the self-sharpening drill bit is applicable to at least standard twist drill bits, Forstner bits, brad-point bits, and spade bits.

In an exemplary embodiment, to achieve gradual or layered changes in a metal object, particularly transitioning from tungsten carbide to high-carbon steel, low-carbon steel, and finally softer metals like copper or aluminum, advanced AM techniques are required. The following methods are well-suited for this purpose: DED; Laser Powder Bed Fusion (LPBF); Binder Jetting with Post-Sintering; Cold Spray Additive Manufacturing (CSAM); Gradient Additive Manufacturing (GAM) Using Wire Arc Additive Manufacturing (WAAM); and Multi-Material Inkjet Printing.

In an exemplary embodiment, some key considerations for material transitions for the drill bit include thermal compatibility (materials must have similar thermal expansion coefficients to avoid cracking during cooling), interfacial bonding (a transition zone or intermediate material may be necessary to ensure strong bonding between dissimilar metals), and process optimization (precise control of energy input, feed rates, and material flow is critical for achieving smooth transitions).

In an exemplary embodiment, the various sections, layers, zones, or functional material gradient of the drill bit may be assembled using traditional annealing methods to achieve blended layering (e.g., Makume-gane) or diffusion bonding where heat and pressure promote atomic diffusion across the interface or threshold therebetween (i.e., atoms of two solid, metallic surfaces intersperse themselves over time).

In an exemplary embodiment, the drill bit utilizes internal geometry and material arrangement that provides for cutting edge renewal. In particular, the geometry is configured such that wear preferentially occurs in non-cutting regions, causing controlled migration or formation of a cutting edge. The wear is directed and functional. In an exemplary embodiment, the drill bit does not comprise a coating. The drill bit instead achieves edge renewal without applied wear coatings, indexable inserts, and removable cutting elements.

In an exemplary embodiment, the drill bit comprises a lattice core, a capillary microchannel network, a porous internal architecture, a heat pipe-like function, phase-change material possibilities, and/or conductive gradient core materials to achieve an internal heat-wicking core. In an exemplary embodiment, the drill bit comprises spiral internal heat channels, flute-integrated heat sinks, core-to-flute thermal bridges, and/or multi-material printing (hard outer/conductive inner) to achieve radial heat conduction pathways. In an exemplary embodiment, the drill bit comprises internal irrigation through the core, directional coolant jets near cutting lips, and/or thermal feedback-based irrigation to achieve irrigation integration.

In an exemplary embodiment, the drill bit may comprise an embedded temperature sensor, a smart drill feature capable of providing feedback regarding the drill bit, a thermal color-change indicator, and/or digital integration.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a front perspective view of a self-sharpening drill bit.

FIG. 2 is a side elevational view of the self-sharpening drill bit shown in FIG. 1.

FIG. 3 is a front elevational view of the self-sharpening drill bit shown in FIG. 1.

FIG. 4 is a partial front perspective schematic view of the self-sharpening drill bit shown in FIG. 1.

FIG. 5 is a detail view of the self-sharpening drill bit taken generally along DETAIL 5 in FIG. 3.

FIG. 6 is a partial cross-sectional view of the self-sharpening drill bit taken generally along line 6-6 in FIG. 1.

FIG. 7 is a detail view of the self-sharpening drill bit taken generally along DETAIL 7 in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element, and a third element; or a device comprising a second element and a third element. A similar interpretation is intended when the phrase “used in at least one of:” is used herein.

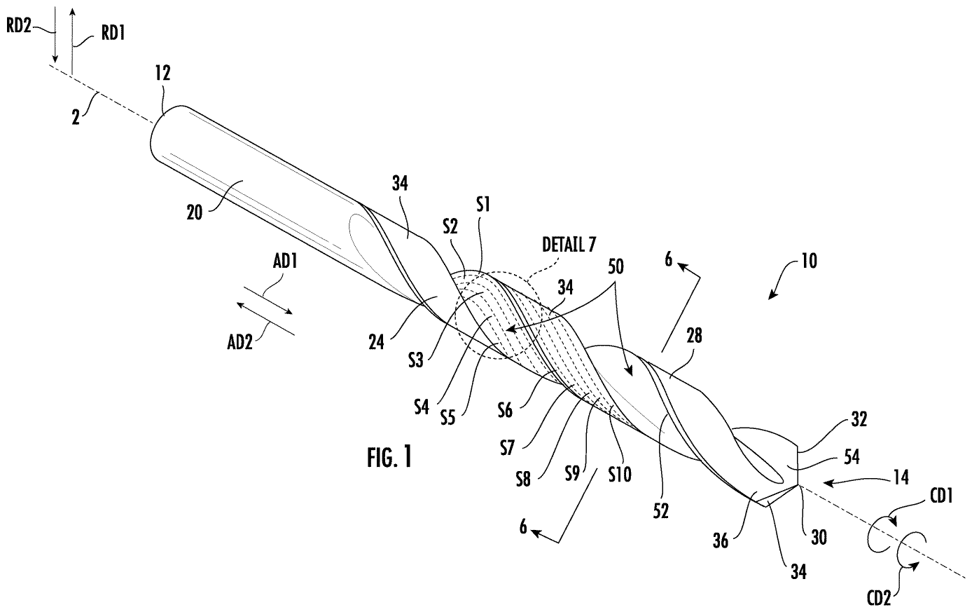

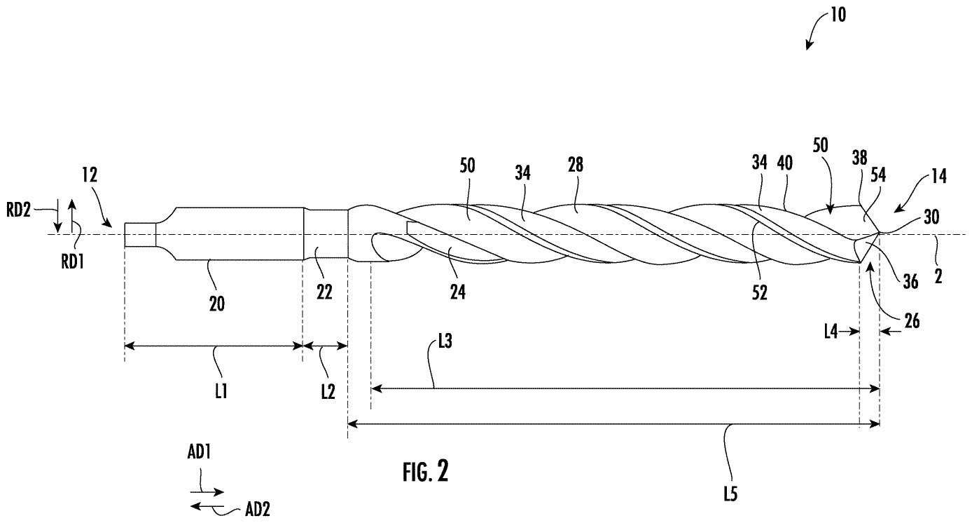

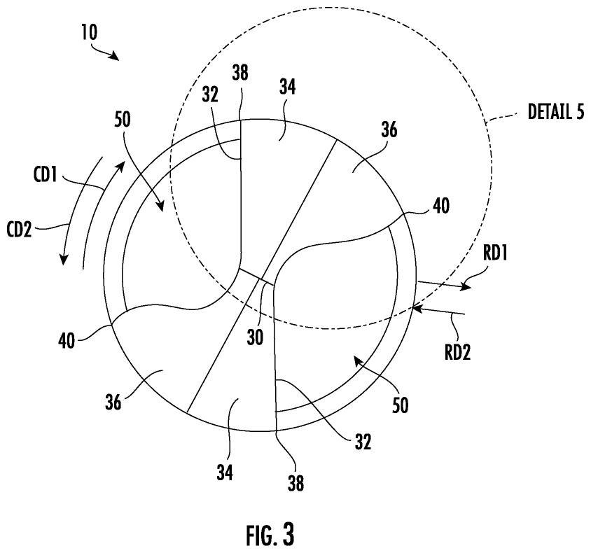

Referring now to the figures, FIG. 1 is a front perspective view of self-sharpening drill bit 10. FIG. 2 is a side elevational view of self-sharpening drill bit 10. FIG. 3 is a front elevational view of self-sharpening drill bit 10.

Self-sharpening drill bit or drill bit 10 generally comprises end 12 arranged to be engaged with a drill or a turning or reciprocating device, and end 14. Drill bit 10 comprises shank 20 arranged proximate or near or at end 12, tip 26 arranged proximate or near or at end 14, and flute section 24 arranged axially between shank 20 and end 14. In an exemplary embodiment, drill bit 10 further comprises neck 22 arranged axially between shank 20 and flute section 24 (see FIG. 2). In an exemplary embodiment, neck 22 comprises a diameter that is less that the diameter of land 50 (i.e., flute section 24) and shank 20. In an exemplary embodiment, flute section 24 constitutes body 28 of drill bit 10. In an exemplary embodiment, flute section 24 and neck 22 constitutes body 28 of drill bit 10. Shank 20 comprises length L1, neck 22 comprises length L2, flute section 24 comprises length L3, tip 26 comprises length L4, and body 28 comprises length L5. As shown in FIG. 2, length L2 is greater than length L4, length L1 is greater than length L2, L3 is greater than length L1, and length L5 is greater than length L3.

Tip 26 comprises point or chisel edge 30, major cutting edge or lip 32 and land 34. Chisel edge 30 is arranged at the tip of drill bit 10 aligned with axis of rotation 2. Chisel edge 30 is operatively arranged to start and continue a hole in a work surface. Cutting edge 32 extends radially outward from chisel edge 30 and ends at cutting edge corner 38. Cutting edge 32 is arranged to cut and lift material out of a hole. As is best shown in FIG. 1, cutting edge 32 is arranged between land 34 and rake face 54.

Land 34 is arranged adjacent to cutting edge 32 in a circumferential direction, for example circumferential direction CD1. Land 34 is operatively arranged to regulate the depth of cut for each revolution of drill bit 10, thereby protecting cutting edge 32. In an exemplary embodiment, tip 26 further comprises flank 36. Flank 36 is arranged adjacent to land 34 in a circumferential direction, for example circumferential direction CD1. It should be appreciated that in some embodiments, drill bit 10 comprises a single land/flank surface arranged circumferentially adjacent to cutting edge 32.

Drill bit 10 further comprises heel 40. In an exemplary embodiment, heel 40 is arranged at the furthest circumferential point of the surface adjacent to cutting edge 32. For example, heel 40 is the edge of the surface circumferentially adjacent cutting surface 32, namely, land 34 and/or flank 36, opposite cutting edge 32. In an exemplary embodiment, heel 40 is located at the most radially outward position of land 34 and/or flank 36. As shown in FIG. 2, heel 40 is the edge of land 34 opposite that of minor cutting edge or lip 52.

Flute 50 extends from end 14 spirally in axial direction AD2. Minor cutting edge 52 is arranged at a first size of flute 50 and heel 40 is arranged at the other side of flute 50. Flute 50 forms rake face 54 which is arranged proximate cutting edge 52. Rake face 54 is the surface wherein chips (material removed during drilling) flow away from cutting edge 32 and/or cutting edge 52.

It should be appreciated that in exemplary embodiments drill bit 10 comprises two or more of the above described features, for example, a plurality of major cutting edges 32, a plurality of lands 34, a plurality of flanks 36, a plurality of flutes 50, a plurality of minor cutting edges 52, and a plurality of rake faces 54.

Drill bit 10 may be formed via a plurality of sections having varying degrees of hardness. As best shown in FIG. 1, flute 50 comprises a plurality of sections, for example sections S1-S5, which decrease in hardness in a direction away from cutting edge 52. Section S1 has the highest material hardness and may comprise, for example, PCD. Section S2 has a material hardness less than the material hardness of section S1 and may comprise, for example, tungsten carbide. Section S3 has a material hardness less than the material hardness of section S2 and may comprise, for example, high carbon steel. Section S4 has a material hardness less than the material hardness of section S3 and may comprise, for example, medium carbon steel, low carbon steel, or a gradient of medium to low carbon steel. Section S5 has a material hardness less than the material hardness of section S4 and may comprise, for example, aluminum or copper.

Likewise, land 34 comprises a plurality of sections, for example sections S6-S10, which decrease in hardness in a direction away from cutting edge 52. Section S6 has the highest material hardness and may comprise, for example, PCD. Section S7 has a material hardness less than the material hardness of section S6 and may comprise, for example, tungsten carbide. Section S8 has a material hardness less than the material hardness of section S7 and may comprise, for example, high carbon steel. Section S9 has a material hardness less than the material hardness of section S8 and may comprise, for example, medium carbon steel, low carbon steel, or a gradient of medium to low carbon steel. Section S10 has a material hardness less than the material hardness of section S9 and may comprise, for example, aluminum or copper.

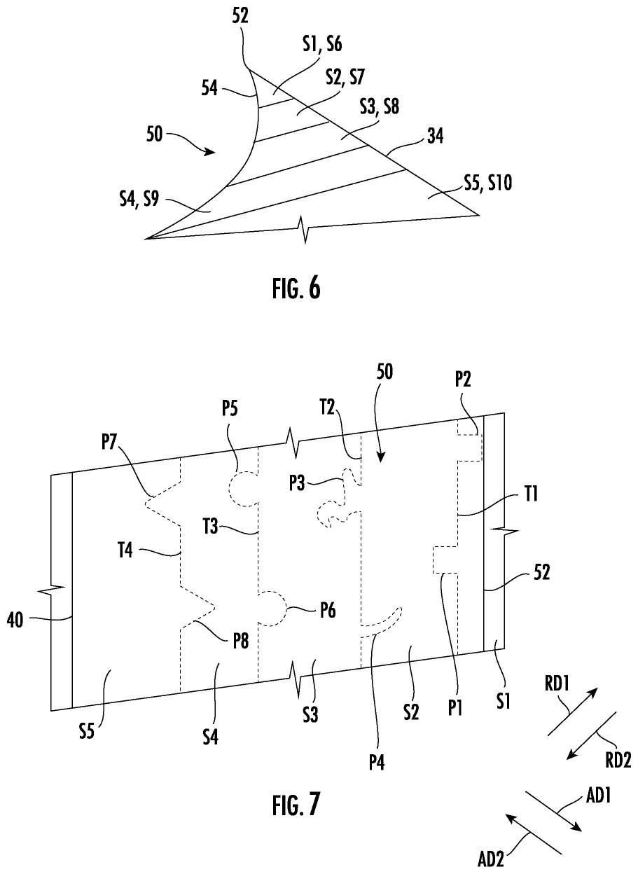

It should be appreciated that in an exemplary embodiment sections S6-S10 may correspond to sections S1-S5, respectively. That is to say that sections S1-S5 are connected to sections S6-S10, respectively. FIG. 6 is a partial cross-sectional view of self-sharpening drill bit 10 taken generally along line 6-6 in FIG. 1. In an exemplary embodiment, and as best shown in FIG. 6, sections S1 and S6 are connected and form a first section extending from flute 50 to land 34, and cutting edge 52. Sections S2 and S7 are connected and form a second section extending from flute 50 to land 34, adjacent the first section. Sections S3 and S8 are connected and form a third section extending from flute 50 to land 34, adjacent the second section. Sections S4 and S9 are connected and form a fourth section extending from flute 50 to land 34, adjacent the third section. Sections S5 and S10 are connected and form a fifth section extending from flute 50 to land 34, adjacent the fourth section.

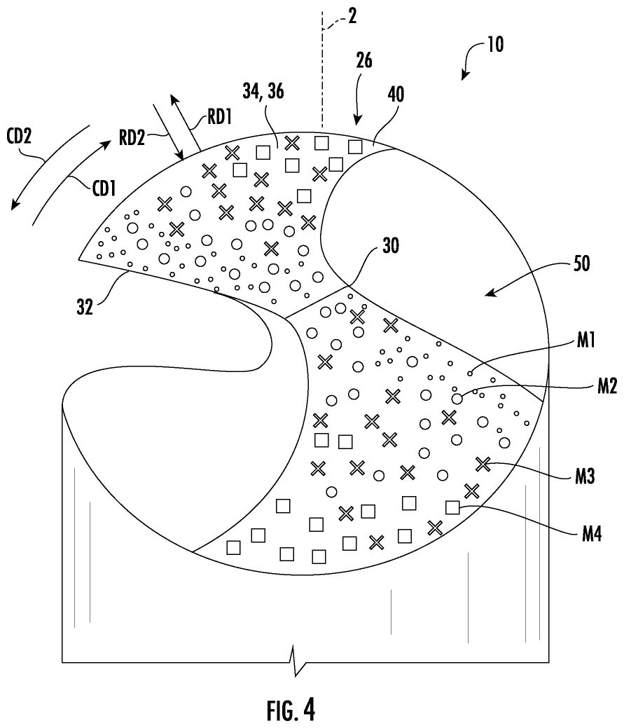

FIG. 4 is a partial front perspective schematic view of self-sharpening drill bit 10. As shown, tip 26, and specifically land 34 and/or flank 36, varies in material hardness in a circumferential direction away from cutting edge 32. For example, first material M1 having the greatest hardness is arranged adjacent cutting edge 32. Material M1 may be, for example, PCD. Second material M2 having a hardness less than the hardness of material M1 is arranged adjacent to material M1. Material M2 may be, for example, tungsten carbide. Third material M3 having a hardness less than the hardness of material M2 is arranged adjacent to material M2. Material M3 may be, for example, high-carbon steel. Fourth material M4 having a hardness less than the hardness of material M3 is arranged adjacent to material M3. Material M4 may be, for example, medium-carbon steel, low-carbon steel, or a gradient of medium to low carbon steel. Fifth material M5 having a hardness less than the hardness of material M4 is arranged adjacent to material M4. Material M4 may be, for example, aluminum and/or copper.

FIG. 4 generally shows a metal mix gradient which decreases in hardness in circumferential direction CD1, away from the cutting edge. The substance composition gradient varies in material hardness with the hardest material clustered at the cutting edge and chisel edge and then gradually fading to softer, less dense material toward the heal. The materials may be randomly integrated within general sections, so as to increase strength between varying materials. Such material gradient helps not only to help maintain sharpness of the cutting edge, but also to remove heat from the drill bit during operation.

The various sections and materials of drill bit 10, for example, materials M1-M5, may be gradually arranged to form drill bit 10 without any coherent or defining transition lines between different materials. This ensures strength during use of drill bit 10 and prevents delamination and fracturing (i.e., separation at the junction between material layers).

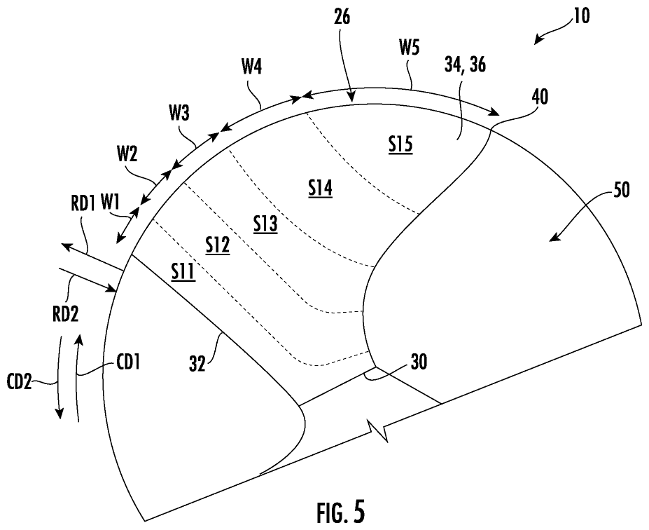

FIG. 5 is a detail view of self-sharpening drill bit 10 taken along DETAIL 5 in FIG. 3. In FIG. 5, general boundary lines are shown between sections S11-S15 which vary in material hardness. While in some embodiments, such boundary lines indicate material differences with no material overlap, in other embodiments such as that shown in FIG. 4 materials may protrude from their respective sections beyond the boundary line or lines and into an adjacent section.

Land 34 and/or flank 36 comprises a plurality of sections, for example sections S11-S15, which decrease in hardness in a direction away from cutting edge 32. Section S11 has the highest material hardness and may comprise, for example, PCD. Section S12 has a material hardness less than the material hardness of section S11 and may comprise, for example, tungsten carbide. Section S13 has a material hardness less than the material hardness of section S12 and may comprise, for example, high carbon steel. Section S14 has a material hardness less than the material hardness of section S13 and may comprise, for example, medium carbon steel, low carbon steel, or a gradient of medium to low carbon steel. Section S15 has a material hardness less than the material hardness of section S14 and may comprise, for example, aluminum or copper.

In an exemplary embodiment, the various sections of drill bit 10, for example sections S11-S15, may be separated by a threshold that extends in a radial and/or circumferential direction. For example, section S11 extends in a radial direction and a circumferential direction, namely, in circumferential direction CD1 with respect to chisel edge 30. Thus, section S11 has a radial extending portion and a circumferential extending portion, arranged adjacent to the radial extending portion. Sections S12, S12, S14, and/or S15 may include a similar arrangement of having a radial extending portion and a circumferential extending portion, arranged adjacent to the radial extending portion.

In an exemplary embodiment, the various sections of drill bit 10, for example sections S11-S15, may differ in width. Section S12 has width W2, which is greater than width W1 of section S11. Section S13 has width W3, which is greater than width W2. Section S14 has width W4, which is greater than width W3. Section S15 has width W5, which is greater than width W4.

It should be appreciated that sections S11-S15 may correspond to sections S1-S5 and/or sections S6-S10, respectively.

In an exemplary embodiment, drill bit 10 comprises phase gradients or blended phase gradients or functionally graded materials represented generally in a direction of sections S1-S15. By functionally graded materials, it is meant that the sections of drill bit 10 exhibit a variation in composition and structure gradually over volume, resulting in corresponding changes in the properties of the material. For example, referring to FIG. 1, drill bit 10 may comprise a functionally material gradient extending generally from phase layer (or functionally graded material zone) S1 to phase layer S5. Drill bit 10 may comprise a functionally material gradient extending from phase layer S6 to phase layer S10. In another example, and referring to FIG. 5, drill bit 10 comprises a functional material gradient extending generally from phase layer S11 to phase layer S15. In an exemplary embodiment, the functionally material gradient is a continuous gradient that decreases in material hardness. In an exemplary embodiment, the functionally material gradient is a discontinuous or stepwise gradient that decreases in material hardness.

FIG. 7 is a detail view of self-sharpening drill bit 10 taken generally along DETAIL 7 in FIG. 1. In an exemplary embodiment, the material of the various sections of drill bit 10 may protrude or bleed into adjacent sections, thereby increasing strength between sections and preventing delamination and fracturing. As shown, section S1, which has a first material (e.g., PCD) and is arranged immediately adjacent to cutting edge 52, comprises protrusion P1 which extends into adjacent section S2. Protrusion P1 is shown as having a square or rectangular geometry; however any suitable geometry can be used. Section S2, which has a second material (e.g., tungsten carbide) and is arranged immediately adjacent to section S1, comprises protrusion P2 which extends into adjacent section S1 and protrusion P3 which extends into adjacent section S3. Protrusion P2 is shown as having a square or rectangular geometry and protrusion P3 is shown having a randomized curvilinear geometry; however any suitable geometry can be used. Section S3, which has a third material (e.g., high-carbon steel) and is arranged immediately adjacent to section S2, comprises protrusion P4 which extends into adjacent section S2 and protrusion P5 which extends into adjacent section S4. Protrusion P4 is shown as having a curvilinear geometry and protrusion P5 is shown having a circular, ovular, or ellipsoidal geometry; however any suitable geometry can be used. Section S4, which has a fourth material (e.g., medium-carbon steel, low-carbon steel, or a gradient of medium to low carbon steel) and is arranged immediately adjacent to section S3, comprises protrusion P6 which extends into adjacent section S3 and protrusion P7 which extends into adjacent section S5. Protrusion P6 is shown as having a circular, ovular, or ellipsoidal geometry and protrusion P7 is shown having a triangular or polygonal geometry; however any suitable geometry can be used. Section S5, which has a fifth material (e.g., aluminum and/or copper) and is arranged immediately adjacent to section S4 and heel 40, comprises protrusion P8 which extends into adjacent section S4. Protrusion P8 is shown having a triangular or polygonal geometry; however any suitable geometry can be used. Note that protrusions P1-P8 cross radially, namely in radial direction RD1, RD2, and axially, namely in axial direction AD1, AD2, into the adjacent section.

In an exemplary embodiment, drill bit 10 comprises a plurality of sections having varying ratios of two materials. For example, a first section closest to the cutting edge has a first ratio (e.g., 90%) of a harder material (e.g., PCD) to a less hard material (e.g., tungsten carbide). A second section adjacent the first section has a second ratio (e.g., 70%) of a harder material (e.g., tungsten carbide) to a less hard material (e.g., high-carbon steel). A third section adjacent the second section has a third ratio (e.g., 60%) of a harder material (e.g., high-carbon steel) to a less hard material (e.g., medium-carbon steel). A fourth section adjacent the third section has a fourth ratio (e.g., 50%) of a harder material (e.g., medium-carbon steel) to a less hard material (e.g., low-carbon steel). A fifth section adjacent the fourth section has a fifth ratio (e.g., 40%) of a harder material (e.g., low-carbon steel) to a less hard material (e.g., aluminum and/or copper).

In an exemplary embodiment, one or more of the materials and sections can be assembled using AM. In an exemplary embodiment, a plurality of materials and sections can be assembled using AM, for example, aluminum, copper, low-carbon steel, medium-carbon steel, high-carbon steel, and/or tungsten carbide, with one or more materials and sections be assembled in an alternative means, for example, PCD may be added using vapor deposition.

In an exemplary embodiment, drill bit 10 may utilize a number of AM techniques for optimal material gradient, as described below.

DED. DED is very well suited for gradient material transitions since it allows real-time composition changes during deposition. DED enables layer-wise integration of ultra-hard cutting materials (e.g., PCD, tungsten carbide, etc.) with structural materials (e.g., high-carbon steel, low-carbon steel, aluminum, etc.).

SLM. SLM produces high-density, fully fused metal components with minimal porosity. SLM allows precise layer-by-layer composition tuning, ensuring a smooth material transition from lip to heel. SLM is well-suited for custom drill bit geometries with intricate internal structures, such as coolant channels.

Binder Jetting (for Tungsten Carbide and PCD). Binder jetting enables powder-based deposition of hard materials such as tungsten carbide and PCD. Binder jetting can be used in combination with sintering techniques to bind ultra-hard cutting edges onto a graded metal substrate.

POSSIBLE 3D PRINTABLE MATERIAL OPTIONS

| | Vickers | Mohs | |
|---|---|---|---|
| Material | Hardness (HV) | Hardness | 3D Printing Method |
| Tungsten Carbide (WC—Co) | 1800-2500 | 8.5-9 | Binder Jetting (Sintering) |
| Cubic Boron Nitride (CBN) | 1600-2000 | 9 | Not commonly 3D printed |
| Titanium Diboride (TiB₂) | 2800-3200 | 9-9.5 | Powder Bed Fusion (PBF) |
| Silicon Carbide (SiC) (Ceramic) | 2500-3100 | 9 | SLA with Ceramic Slurry |
| Chromium Carbide (Cr₃C₂) | 1200-1500 | 8-8.5 | Powder Bed Fusion |
| Aluminum Oxide (Al₂O₃) (Ceramic) | 1600-2000 | 9 | SLA with Ceramic Slurry |
| Zirconia (ZrO₂) (Ceramic) | 1200-1400 | 8.5 | SLA with Ceramic Slurry |
| Titanium Carbide (TiC) | 1800-2500 | 9-9.5 | Binder Jetting (Sintering) |
| Tool Steel (A2, D2, M2, H13) | 600-850 | 7-8 | DMLS/SLM |
| Stainless Steel (316L, 17-4 PH) | 200-650 | 5-6.5 | DMLS/SLM/Binder |
| | | | Jetting |
| Inconel (Nickel Superalloy) | 250-650 | 5.5-6.5 | DMLS/SLM |
| Titanium (Ti—6Al—4V) | 350-400 | 6 | DMLS/SLM |
| Cobalt-Chromium (Co—Cr) | 500-850 | 5.5-6 | DMLS/SLM |
| Nickel Alloy (Hastelloy, Monel) | 200-450 | 5-6 | DMLS/SLM |
| Bronze (Cu—Sn Alloy) | 50-150 | 3-4 | Binder Jetting |
| Brass (Cu—Zn Alloy) | 80-150 | 3-4 | Binder Jetting |
| Copper (Cu) | 40-120 | 2.5-3 | DMLS/SLM/Binder |
| | | | Jetting |
| Aluminum Alloys (AlSi10Mg, 6061, | 100-180 | 2.5-3.5 | DMLS/SLM/Binder |
| 7075) | | | Jetting |

The material composition of the drill bit may be optimized based on its intended application (e.g., metal drilling, composite drilling, rock drilling), and the material gradient can be tailored accordingly.

In an exemplary embodiment, for example for high-performance industrial drilling (metal and composite materials), the drill bit may comprise a cutting lip or first section including PCD and/or CBN (for extreme hardness and wear resistance), a transition zone or second section including Tungsten Carbide and/or Cobalt (WC—Co) fading into high-carbon tool steel for fracture toughness, a third section including medium-carbon steel to provide a balance of strength and flexibility, and a heel or fourth section including low-carbon steel or aluminum (fast-wearing for self-sharpening effect).

In an exemplary embodiment, for example for heavy-duty rock and concrete drilling, the drill bit may comprise a cutting lip or first section including Tungsten Carbide with a diamond coating (high impact and wear resistance), a transition zone or second section including Titanium Carbide (TiC) and/or high-speed steel (HSS) (to resist heat and impact), a third section including tempered tool steel or stainless steel (corrosion resistance in wet drilling), and a heel or fourth section including Copper or Bronze alloy (fast-wearing under mechanical stress).

In an exemplary embodiment, for example for wood and soft material drilling, the drill bit may comprise a cutting lip or first section including HSS with a diamond-like carbon (DLC) coating, a transition zone or second section including hardened steel or titanium-coated steel, a third section including high-carbon steel for durability, and a heel or fourth section including aluminum or brass (easy wearing for self-sharpening).

In an exemplary embodiment, the drill bit may comprise internal coolant channels. For example, using SLM, coolant channels can be 3D-printed within the drill bit body to enhance heat dissipation and extend tool life. Such coolant channels will aid in high-speed drilling applications where thermal management is critical.

In an exemplary embodiment, the drill bit may comprise variable flute geometry. The flute geometry can be adjusted to accommodate material wear and ensure efficient chip evacuation as the drill wears. Using adaptive manufacturing, the flutes can be reinforced near the cutting edges while maintaining wear-prone regions at the heel.

In an exemplary embodiment, the drill bit may comprise one or more coatings for enhanced performance. For example, a DLC or titanium-aluminum-nitride (TiAlN) coating can be applied to the drill bit to further reduce friction and extend tool life.

In an exemplary embodiment, the drill bit may comprise more cost conscious materials and be assembled using cost conscious manufacturing processes. While advanced materials like PCD and CBN offer superior hardness, they increase manufacturing costs. For example, the drill bit may be assembled using a hybrid additive-subtractive manufacturing approach, wherein the drill bit comprises a core and heel assembled with AM using SLM, DED, or binder jetting for functionally graded material integration, a cutting lip assembled with pre-manufactured ultra-hard inserts (e.g., carbide inserts or coated HSS) fused via laser cladding or brazing to reduce AM processing costs. The process of manufacturing the drill bit may also post-processing such as CNC machining and/or grinding for precision geometry and tolerance control after printing. The use of such processes reduces raw material and printing time while retaining self-sharpening properties. In an exemplary embodiment the hybrid manufacturing may comprise a printed core and a machined outer layer.

Instead of premium-grade diamond coatings such as PCD and CBN, more cost-effective alternatives can be used. The use of such alternative materials maintains self-sharpening function while reducing material costs, for example by 30-50%.

ALTERNATIVE MATERIAL COMBINATIONS
FOR COST REDUCTION

| | | Industry |
|---|---|---|
| Premium Material | Cost-Optimized Alternative | Suitability |
| PCD/CBN Cutting | Titanium Aluminum Nitride | General metal |
| Edge | (TiAlN) Coating on Carbide | machining |
| Tungsten Carbide | Titanium Carbide (TiC) or | Aerospace, |
| Transition Layer | Chromium Carbide (CrC) | automotive |
| High-Carbon Steel | Hardened Tool Steel (e.g., A2, | Industrial & |
| Core | D2) | DIY markets |
| Aluminum/Copper | Soft Bronze or Magnesium | Construction, |
| Heel | Alloy | wood drilling |

To expand the use of the drill bit in different industries, the following industry-specific modifications can be applied.

In an exemplary embodiment, for example for metal and composite drilling (aerospace, automotive, manufacturing, etc.), the drill bit may comprise a cutting lip including chemical vapor deposition diamond-coated Tungsten Carbide (heat-resistant for composites and metals), a core including HSS for cost efficiency and toughness, a heel including an Aluminum-Titanium alloy (lightweight and wear-prone for self-sharpening), and flute optimization, for example a variable pitch helix to minimize vibration during high-speed cutting.

In an exemplary embodiment, for example for concrete and rock drilling (construction, mining, oil and gas, etc.), the drill bit may comprise a cutting lip including Tungsten Carbide inserts with sintered diamond particles, a core including tempered tool steel (shock-resistant), a heel including a Copper-based alloy (self-sacrificing wear zone), and one or more coolant channels, for example integrated via AM for dust and heat control.

In an exemplary embodiment, for example for woodworking and soft materials (carpentry, personal use, consumer market), the drill bit may comprise a cutting lip including Titanium-Nitride (TiN) coated HSS, a core including medium-carbon steel, and a heel including Brass or Magnesium Alloy (low-cost and high-wear for self-sharpening).

In an exemplary embodiment, the drill bit may be assembled using hybrid manufacturing for large-scale production, comprising batch printing drill blanks (e.g., using SLM or binder jetting) with pre-defined material gradients, CNC finishing to ensure precise cutting lip geometries, coating and heat treatment for optimized durability (e.g., TiAlN, TiN, DLC coatings), and/or automated quality control using optical scanning for consistency in gradient wear profiles.

In an exemplary embodiment, the drill bit may be assembled using a modular drill design for industry flexibility, wherein the drill bit comprises interchangeable cutting tips wherein AM-produced self-sharpening tips that attach to standardized drill bit bodies, customizable material gradients tailored based on industry needs without changing the full drill bit structure, and/or reusable drill bit bodies that replace only the worn cutting edges, reducing material waste and cost.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

2 Axis of rotation
10 Self-sharpening cutting tool or drill bit
12 End
14 End
20 Shank
22 Neck
24 Body
26 Tip
30 Point or chisel edge
32 Major cutting edge
34 Land
36 Flank
38 Cutting edge corner
40 Heel
50 Flute
52 Minor cutting edge
54 Rake face
AD1 Axial direction
AD2 Axial direction
CD1 Circumferential direction
CD2 Circumferential direction
L1 Length
L2 Length
L3 Length
L4 Length
L5 Length
M1 Material
M2 Material
M3 Material
M4 Material
P1 Protrusion
P2 Protrusion
P3 Protrusion
P4 Protrusion
P5 Protrusion
P6 Protrusion
P7 Protrusion
P8 Protrusion
RD1 Radial direction
RD2 Radial direction
S1 Section or phase layer or functionally graded material zone
S2 Section or phase layer or functionally graded material zone
S3 Section or phase layer or functionally graded material zone
S4 Section or phase layer or functionally graded material zone
S5 Section or phase layer or functionally graded material zone
S6 Section or phase layer or functionally graded material zone
S7 Section or phase layer or functionally graded material zone
S8 Section or phase layer or functionally graded material zone
S9 Section or phase layer or functionally graded material zone
S10 Section or phase layer or functionally graded material zone
S11 Section or phase layer or functionally graded material zone
S12 Section or phase layer or functionally graded material zone
S13 Section or phase layer or functionally graded material zone
S14 Section or phase layer or functionally graded material zone
S15 Section or phase layer or functionally graded material zone
T1 Threshold
T2 Threshold
T3 Threshold
T4 Threshold
W1 Width
W2 Width
W3 Width
W4 Width
W5 Width

What is claimed is:

1. A self-sharpening drill bit, comprising:
an axis of rotation;
a proximal end;
a distal end including a tip, the tip comprising:
at least one major cutting edge;
a first land extending in a first circumferential direction and a first axial direction from the at least one major cutting edge and ending at a heel; and
a flute section including:
at least one flute extending from the tip;
a minor cutting edge arranged at a first side of the at least one flute; and
a second land arranged at a second side of the at least one flute, opposite the first side;
wherein:
the self-sharpening drill bit comprises a plurality of sections;
each section of the plurality of sections comprises a material hardness; and
the material hardness of the plurality of sections decreases in the first circumferential direction from at least one of the major cutting edge and the minor cutting edge.

2. The self-sharpening drill bit as recited in claim 1, wherein the plurality of sections comprises:
a first section forming the major cutting edge and/or the minor cutting edge, the first section including a first hardness; and
a second section arranged circumferentially adjacent to the first section and having a second hardness, less than the first hardness.

3. The self-sharpening drill bit as recited in claim 2, wherein the plurality of sections further comprises:
a third section arranged circumferentially adjacent to the second section and having a third hardness, less than the first hardness; and
a fourth section arranged circumferentially adjacent to the third section and having a fourth hardness, less than the third hardness.

4. The self-sharpening drill bit as recited in claim 3, wherein:
the first section comprises polycrystalline diamond;
the second section comprises tungsten carbide;
the third section comprises a transition from high-carbon steel to low-carbon steel; and
the fourth section comprises aluminum and/or copper.

5. The self-sharpening drill bit as recited in claim 2, wherein:
the first section comprises a first protrusion that extends into the second section; and/or
the second section comprises a second protrusion that extends into the first section.

6. The self-sharpening drill bit as recited in claim 5, wherein the first protrusion and/or the second protrusion extend in a radial direction and an axial direction with respect to the axis of rotation.

7. The self-sharpening drill bit as recited in claim 1, wherein the plurality of sections increase in width in the first circumferential direction.

8. The self-sharpening drill bit as recited in claim 1, wherein at least one section of the plurality of sections comprises:
a circumferential portion extending completely from the major cutting edge to the first heel; and
a radial portion extending from the circumferential portion along the major cutting edge to a cutting edge shoulder.

9. The self-sharpening drill bit as recited in claim 1, wherein at least one section of the plurality of sections comprises:
a circumferential portion extending to the first heel; and
a radial portion extending from the circumferential portion to a radially outward facing surface of the self-sharpening drill bit.

10. The self-sharpening drill bit as recited in claim 2, wherein:
a first section forms the minor cutting edge and extends from the flute to the second land; and
the second section extends from the flute to the second land.

11. A self-sharpening drill bit, comprising:
an axis of rotation;
a proximal end including a shank;
a distal end including a tip, the tip comprising:
at least one major cutting edge;
a first land extending in a first circumferential direction and a first axial direction from the at least one major cutting edge and ending at a heel;
a flute section including:
at least one flute extending from the tip;
a minor cutting edge arranged at a first side of the at least one flute; and
a second land arranged at a second side of the at least one flute, opposite the first side;
wherein:
the self-sharpening drill bit comprises a plurality of layers arranged in a first circumferential direction from the major cutting edge to the first heel and/or the minor cutting edge to the second heel;
each layer of the plurality of layers comprises a material hardness; and
the material hardness of each layer decreases in the first circumferential direction.

12. The self-sharpening drill bit as recited in claim 11, wherein the plurality of layers comprise:
a first layer forming the major cutting edge and/or the minor cutting edge, the first layer including a first hardness;
a second layer arranged circumferentially adjacent to the first layer and having a second hardness, less than the first hardness;
a third layer arranged circumferentially adjacent to the second layer and having a third hardness, less than the first hardness; and
a fourth layer arranged circumferentially adjacent to the third layer and having a fourth hardness, less than the third hardness.

13. The self-sharpening drill bit as recited in claim 12, wherein:
the first layer comprises polycrystalline diamond;
the second layer comprises tungsten carbide;
the third layer comprises a transition from high-carbon steel to low-carbon steel; and
the fourth layer comprises aluminum and/or copper.

14. The self-sharpening drill bit as recited in claim 11, wherein:
the plurality of layers comprise a first layer comprising a first material and a second layer comprising a second material, different than the first material; and
the first layer comprises at least one protrusion including the first material and extending into the second layer.

15. The self-sharpening drill bit as recited in claim 14, wherein the at least one protrusion extends in a radial direction and an axial direction with respect to the axis of rotation.

16. The self-sharpening drill bit as recited in claim 11, wherein the plurality of layers increase in width in the first circumferential direction.

17. The self-sharpening drill bit as recited in claim 11, wherein at least one layer of the plurality of layers comprise:
a circumferential portion extending to the first heel; and
a radial portion extending from the circumferential portion to a radially outward facing surface of the self-sharpening drill bit.

18. The self-sharpening drill bit as recited in claim 11, wherein the plurality of layers comprise:
a first layer forming the minor cutting edge, the first layer including a first hardness, the first layer extending from the flute to the second land; and
a second layer arranged circumferentially adjacent to the first layer and having a second hardness, less than the first hardness, the second layer extending from the flute to the second land.

19. A self-sharpening cutting tool configured to form a hole in a substrate, comprising:
a first side;
a second side;
a cutting edge, the first side and the second side forming the cutting edge; and
a functionally graded material gradually decreasing in hardness in a direction away from the cutting edge.

20. The self-sharpening cutting tool as recited in claim 19, wherein the functionally graded material comprises:
a first functionally graded material zone forming the cutting edge and including a first majority material having a first hardness; and
a second functionally graded material zone arranged adjacent the cutting edge and including a second majority material having a second hardness, less than the first hardness.
